(19) United States
(12) Patent Application Publication
(10) Pub. No.: US 2024/0293903 A1
(43) Pub. Date: Sep. 5, 2024

(54) MACHINE TOOL REINFORCED VACUUM LINE

(71) Applicant: AES ELEKTRONIK MAKINA SANAYI VE TICARET ANONIM SIRKETI, BURSA (TR)

(72) Inventor: Orhan KEYIF, BURSA (TR)

(21) Appl. No.: 18/044,350

(22) PCT Filed: Apr. 4, 2022
(86) PCT No.: PCT/TR2022/050293

§ 371 Date: Mar. 7, 2023

(51) Int. Cl. B23Q 3/08

(52) U.S. Cl. CPC B23Q 3/088

(57) ABSTRACT

A machine tool includes a worktable to which the workpiece is placed on; a vacuum line which applies vacuum pressure to clamp the workpiece on said worktable; a vacuum box which connects the vacuum line to the worktable; an additional vacuum line which is positioned under said worktable and connected to the vacuum box to tightly clamp the workpiece to the worktable by applying vacuum pressure only to the vacuum box located in the workpiece area; an additional line actuator which is installed at the end portions of the additional vacuum line that connect to vacuum boxes to manage air flow; and an additional line pneumatic valve which activates/deactivates the desired additional line actuator to apply full vacuum power to the relevant area.

### TECHNICAL FIELD

The present invention relates to a vacuum system designed for clamping a workpiece to the worktable of wood, plastic, and aluminium machine tools.

More specifically, the invention relates to an additional vacuum line that fully clamps the workpiece to the worktable, thereby enabling machining of the workpiece with minimum errors.

### PRIOR ART

Today, vacuum systems are used for clamping workpieces on the worktable of wood, plastic and aluminium machine tools.

In existing applications, since the vacuum generated by the vacuum line is applied to the entirety of the worktable, not enough vacuum can be applied to the workpiece to be machined. This causes the workpiece to move during the operation of the spindle, thereby leading to inefficient machining.

According to the prior art, inefficient machining means the finished product has poor quality, which results in unused products and higher production cost.

As part of the prior art, manufacturing of unused products increases labour costs and also reduces the number of premium quality products manufactured per unit of time.

In existing applications, the undesirable movement of the workpiece during the operation leads to occupational accidents.

According to the literature review, various vacuum system embodiments are designed for said machine tools, one of which is the patent application no. TR2020/01247, titled “VACUUM SYSTEM ADDITIONAL LINE”. Registered under classification B60J 5/06, the invention relates to a vacuum system additional line used for clamping a workpiece (wood workpiece to be machined) in wood machine tools, wherein the vacuum system is a system used for clamping the workpiece to the worktable.

Said application employs one vacuum line to clamp the workpiece to the worktable. Since this vacuum line vacuums not only the work area, but the whole worktable, the range of vacuum applied on the workpiece remains low. Therefore, said application can be viewed as an example of the mentioned disadvantages.

In conclusion, developments are taking place in the vacuum systems of machine tools in parallel with the advances in technology, therefore new configurations are necessary to eliminate the drawbacks explained above and provide solutions to the existing systems.

### SUMMARY OF THE INVENTION

The present invention relates to a vacuum system different from those employed in the prior art in that it is designed for eliminating said disadvantages and bringing certain advantages to the technical field.

The object of the invention is to reinforce the vacuum applied to the workpiece to be machined thanks to an additional vacuum line. This allows for properly clamping the workpiece to the worktable and keeping it fixed during operation.

Another object of the invention is to ensure only the vacuum box in the working area of the additional vacuum line applies vacuum pressure. This allows for concentrating all vacuum power in a single area so that the workpiece is better retained by the worktable.

Another object of the invention is to amplify vacuum pressure to make sure the workpiece remains fixed during operations, thereby enabling efficient machining.

Another object of the invention is to eliminate potential occupational accidents by keeping the workpiece fixed.

Yet another object of the invention is to increase manufacturing of premium quality products by minimizing errors.

The below drawings and the detailed description set out with reference to the accompanying drawings provide for a clearer understanding of the structural characteristics and all benefits of the present invention; therefore, the evaluation needs to take these drawings and the detailed description into account.

### BRIEF DESCRIPTION OF THE DRAWINGS

FIG. 1 is a perspective view of the additional vacuum line installed to the worktable according to the invention.

FIG. 2 is a perspective view of the regular vacuum line and additional vacuum line installed to the worktable according to the invention.

FIG. 3 is an exploded perspective view of the vacuum box and worktable.

FIG. 4 is a perspective view of two separate vacuum lines installed to the machine tool.

### LIST OF REFERENCE NUMERALS

1. Machine tool
100. Vacuum line
110. Vacuum pump inlet
120. Vacuum pipe
130. Actuator
140. Pneumatic valve
200. Additional vacuum line
210. Additional line vacuum pump inlet
220. Additional line vacuum pipe
230. Additional line pneumatic valve
240. Additional line actuator
300. Vacuum box
310. Vacuum box fitting
320. Vacuum hose
330. Vacuum pipe inlet
340. Additional line vacuum pipe inlet
400. Worktable
410. Worktable fitting
420. Vacuum holes
500. Spindle
600. Main body

### Detailed Description of an Embodiment of the Invention

For a better understanding of the invention, this detailed description demonstrates the preferred embodiments of the machine tool (1) according to the invention in a non-limiting manner.

### Working Principle

Said machine tool (1) comprises a vacuum line (100), an additional vacuum line (200), vacuum boxes (300), a worktable (400), and a spindle (500).

Said vacuum line (100) is a prior art line, comprising a vacuum pump inlet (110), a vacuum pipe (120), an actuator (130) and a pneumatic valve (140). Vacuum pump inlet (110) serves as a connection between the vacuum pipe (120) and the machine tool (1). The vacuum pipe (120) is necessary for transmitting the vacuum. The actuator (130) opens the related sections of the worktable (400) while the pneumatic valve (140) controls the actuator (130). A perspective view of these components is shown in FIG. 2.

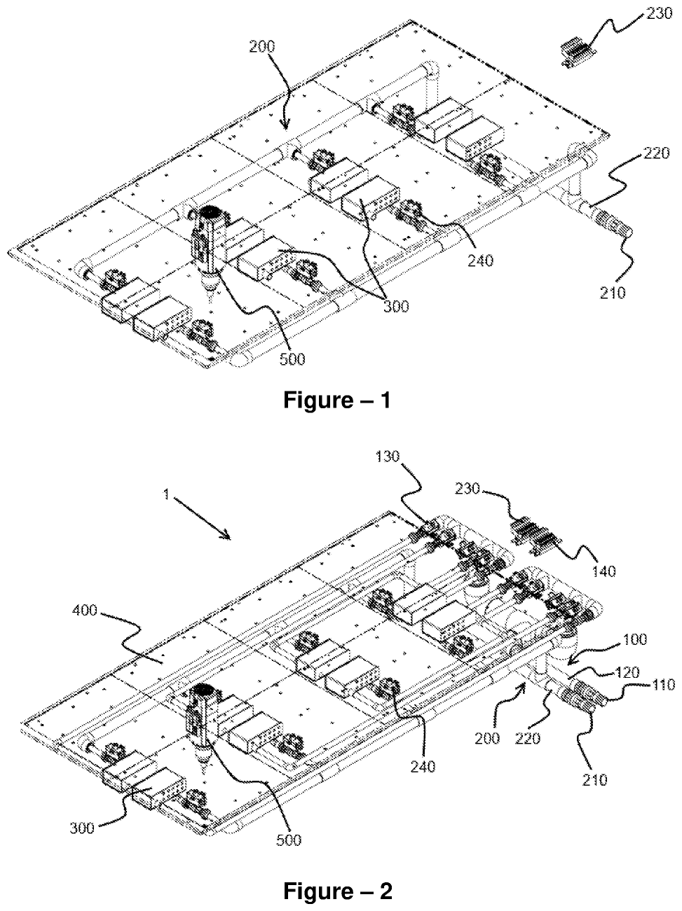

The additional vacuum line (200), according to the invention, comprises an additional line vacuum pump inlet (210), an additional line vacuum pipe (220), an additional line pneumatic valve (230), and an additional valve actuator (240), the perspective view of which is shown in FIG. 1. In general terms, these components serve the same functions as vacuum line (100) components.

Said vacuum boxes (300) contain the air required to generate vacuum pressure. The vacuum boxes (300) are positioned on the worktable (400). The worktable (400) is the main structure where the workpiece to be machined is positioned and retained with vacuum pressure. The spindle (500) machines the workpiece to be machined.

A vacuum box fitting (310) and a vacuum hose (320) is used to connect the vacuum box (300) to the worktable (400). In addition, an additional line vacuum pipe inlet (340) is located at the bottom section of the vacuum box (300) to connect the additional line vacuum pipe (220) coming from the additional vacuum line (200). The vacuum pipe inlet (30) is located at the side section of the vacuum box (300) to connect the vacuum pipe (120) coming the from vacuum line (100).

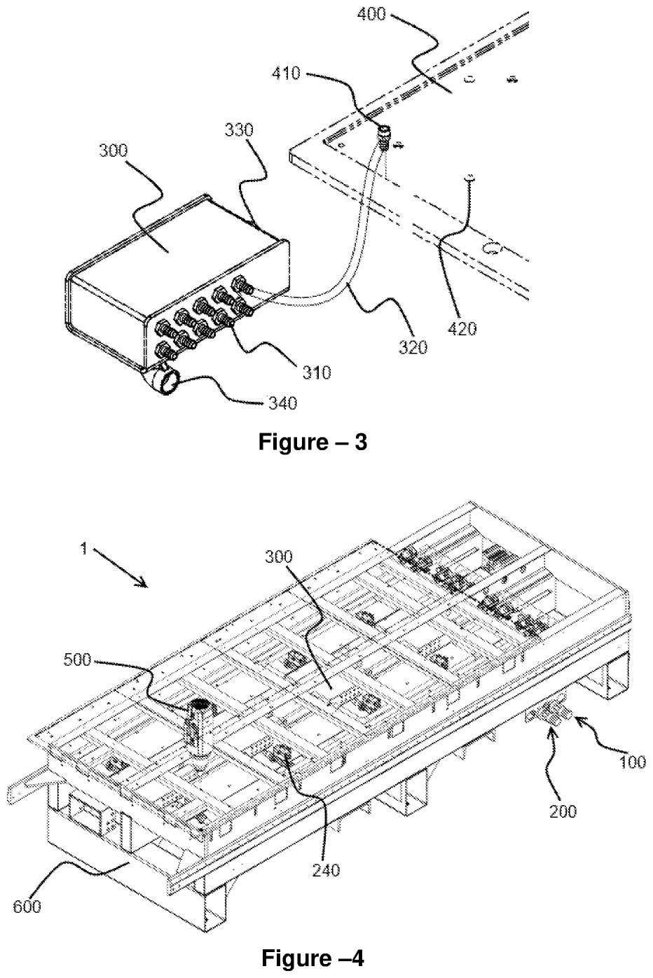

Vacuum holes (420) are formed on the worktable (400) to connect said vacuum hoses (320) to the worktable (400). Said vacuum hoses (320) are connected to the worktable fittings (410) placed on the vacuum holes (420). FIG. 3 shows a perspective view of the vacuum box (300) and worktable (400).

### Assembly Principle

Machine tool (1) is obtained by assembling the components listed above to the main body (600). Vacuum boxes (300) as well as the vacuum line (100) and the additional vacuum line (200) connected to the vacuum boxes (300) are assembled to the main body (600).

The additional vacuum line (200) according to the invention is assembled as shown in FIG. 1. The additional vacuum pipes (220) connected to the additional line vacuum pump inlet (210) are longitudinally extended from the sides of the entire worktable (400) so that they stay under the worktable (400). The additional line vacuum pipes (220) are separately extended to vacuum boxes (300) which are placed at certain intervals and connected from the additional line vacuum pipe inlet (340). Just before these inlets, an additional line actuator (240) is connected for each inlet. An additional line pneumatic valve (230) is installed to the starting point of the additional line vacuum pipes (220).

The vacuum line (100) assembly is performed in a way identical to that of the additional vacuum line (200) with the only difference that actuators (130) are lined at the starting portion. Vacuum pipes (120) extending from the actuators (130) are inserted to the vacuum pipe inlets (330) of vacuum boxes (300) to complete the connection. FIG. 2 shows a perspective view of the structure which houses the initial vacuum line (100) and the additional vacuum line (200).

The worktable (400) is positioned on this structure and fastened to the main body (600). Vacuum box fittings (310) of each vacuum box (300) are connected to vacuum holes (420) by means of vacuum hoses (320). This assembly is clearly shown in FIG. 3. This makes it possible to connect both vacuum lines to the worktable (400). FIG. 4 shows a fully assembled machine tool (1).

### Working Principle

The workpiece to be machined is placed on the worktable (400). The vacuum line (100) and the additional vacuum line (200) is operated to clamp the workpiece to the worktable (400).

The vacuum box (300) located at the area where the spindle (500) is active is determined thanks to the algorithm used by the control unit of the additional vacuum line (200) according to the invention. Then, vacuum power is transmitted only to the related vacuum box (300) to amplify vacuum power in the working area. This makes it possible for the additional vacuum line (200) to apply vacuum pressure only the workpiece area. With this step, the workpiece is properly retained by the worktable (400) and workpiece sliding or other faults are avoided. Therefore, machining is performed with minimum errors and machining quality is improved.

1. A machine tool comprising a worktable to which a workpiece is placed on; a vacuum line which applies vacuum pressure to clamp the workpiece on said worktable; and a vacuum box which connects said vacuum line to the worktable, further comprising:
an additional vacuum line, which is positioned under said worktable and connected to the vacuum box to tightly clamp the workpiece to the worktable by applying vacuum pressure only to the vacuum box located in the workpiece area and comprising:
an additional line vacuum pump inlet at a starting point of said additional vacuum line, which connects to the vacuum pump;
an additional line vacuum pipe which connects to each vacuum box by way of attachment to said additional line vacuum pump inlet;
an additional line actuator which is installed at the end portions of said additional line vacuum pipes that connect to vacuum boxes to manage air flow; and
an additional line pneumatic valve which activates/deactivates the desired additional line actuator to apply full vacuum power to the relevant vacuum box.

2. The machine tool according to claim 1, comprising an additional line vacuum pipe inlet at the vacuum box to connect the additional line vacuum pipe.

3. A machine tool vacuum line operating method, comprising the following steps:
placing a workpiece to be machined on a worktable;
operating an existing vacuum line, connecting the vacuum box through an initial inlet vacuum box fitting to fix the workpiece to be machined by vacuum pressure;
operating an additional vacuum line;
issuing a command to an additional line actuator connected to the vacuum box located under the active area of a spindle to apply additional vacuum pressure only to the relevant vacuum box; and
tightly clamping the workpiece to the worktable by applying the vacuum pressure generated by the additional vacuum line only to the workpiece.
